(19) United States
(12) Patent Application Publication
(10) Pub. No.: US 2015/0201601 A1
(43) Pub. Date: Jul. 23, 2015

(54) RACK FOR ICE FISHING ACCESSORIES

(71) Applicant: Michael A. Honermann, Mitchell, SD (US)

(72) Inventor: Michael A. Honermann, Mitchell, SD (US)

(21) Appl. No.: 14/601,943

(22) Filed: Jan. 21, 2015

Related U.S. Application Data
(60) Provisional application No. 61/929,714, filed on Jan. 21, 2014.

(51) Int. Cl. A01K 97/01; A01K 97/10

(52) U.S. Cl. CPC A01K 97/01; A01K 97/10

(57) ABSTRACT

An ice fishing rod rack includes a rod support, a handle support ring and tab, a base plate, and a securing element. The rod support element including a first notch configured to receive a rod portion of the ice fishing rod. The handle support ring is configured to receive a proximal portion of an ice fishing rod handle, and the handle support tab is positioned to support the proximal end of the ice fishing rod handle. The base plate extends between the rod support and the handle support ring and tab. The securing element is rotatably secured to the rod support element and includes a second notch. The securing element is rotatable such that terminal ends of the first and second notches are urged against the rod portion to hold the rod portion against the rod support element.

### CROSS-REFERENCE TO RELATED APPLICATIONS

This application claims the benefit of Provisional Application No. 61/929,714, filed Jan. 21, 2014, entitled “ICE FISHING ROD RACK,” which is incorporated herein by reference in its entirety.

### TECHNICAL FIELD

The present invention relates generally to recreational activities. More specifically, the present invention relates to a holder or rack for an ice fishing rod and ice fishing related devices and accessories.

### BACKGROUND

Ice fishing is the practice of catching fish with lines and fish hooks through an opening in the ice on a frozen body of water. Ice anglers may sit on the stool in the open on a frozen lake, or in portable shelter or heated cabin on the ice. An ice saw, auger, or chisel is used to cut a circular or rectangular hole in the ice. The ice angler can use a variety of tools to catch fish through the hole in the ice, including an ice fishing rod, rattle line, or spear.

An ice fishing rod is shorter than a conventional fishing pole since the ice angler does not need the whip action of the longer pole to cast the fishing line, and because the ice angler positions the ice fishing rod near the hole in the ice while fishing. To increase the chances of catching fish, the ice angler may use several ice fishing rods, each with a line dropped in a separate hole in the ice. When transporting and storing the multiple rods, the rods should be positioned separately so the lines on the rods do not become entangled. Additionally, the poles should be stored such that the rods are supported to prevent damage to the rods.

### SUMMARY

An ice fishing rod rack includes a rod support, a handle support ring and tab, a base plate, and a securing element. The rod support element including a first notch configured to receive a rod portion of the ice fishing rod. The handle support ring extends substantially parallel to the rod support, and the handle support tab is angled with respect to the handle support ring. The handle support ring is configured to receive a proximal portion of an ice fishing rod handle, and the handle support tab is positioned to support the proximal end of the ice fishing rod handle. The base plate extends between the rod support and the handle support ring and tab. The securing element is rotatably secured to the rod support element and includes a second notch. The securing element is rotatable such that terminal ends of the first and second notches are urged against the rod portion to hold the rod portion against the rod support element. In some embodiments, the rod support element, handle support ring and tab, and base plate are comprised of a continuous piece of material. In some embodiments, the rod support element, handle support ring and tab, base plate, and/or securing element are comprised of metal or plastic. The base plate can include means for securing the ice fishing rod rack to a support substrate. In some embodiments, the means for securing comprises one or more hooks formed in the base plate or an adhesive material. In some embodiments, the base plate is configured for securing to a bucket, wherein the base plate includes one or more hooks configured to couple with one or more corresponding holes on the bucket.

In some aspects, a method for using the ice fishing rod rack includes placing the proximal end of the ice fishing rod handle through the handle support ring and against the handle support tab, placing the rod portion of the ice fishing rod against the terminal end of the first notch on the rod support element, and rotating the securing element until the terminal end of the second notch is against rod portion.

In a further aspect, the present disclosure relates to a rack for supporting an ice fishing accessory comprising. The rack includes a base plate having a first end and second end. A first support element extends substantially orthogonally from the base plate at the first end and includes a structure configured to stabilize the ice fishing accessory with respect to a major plane of the first support element. A second support element extends from the second end of the base plate and configured to contact a bottom portion of the ice fishing accessory to stabilize the ice fishing accessory at least with respect to a direction perpendicular to the major plane of the first support element.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of a plurality of ice fishing rod racks according to the present disclosure secured to a vessel, each ice fishing rod rack supporting an ice fishing rod.

FIGS. 2A-2C are perspective, front, and side views of the ice fishing rod rack according to the present disclosure.

FIG. 3 is an exploded plan view of the components of the ice fishing rod rack according to the present disclosure prior to being shaped and assembled.

FIG. 4 is a perspective view of an ice fishing scoop rack according to another embodiment of the present disclosure.

FIG. 5 is a perspective view of the ice fishing scoop rack shown in FIG. 4 supporting an ice fishing scoop.

FIG. 6 is a perspective view of a beverage container rack according to another embodiment of the present disclosure.

FIG. 7 is a perspective view of the beverage container rack shown in FIG. 6 supporting a beverage can.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

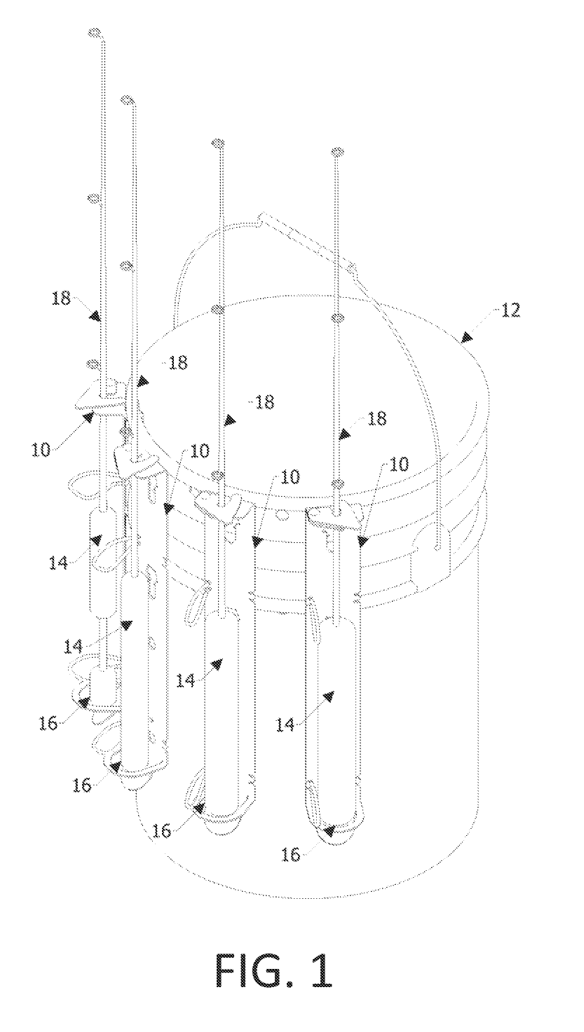

FIG. 1 is a perspective view of a plurality of ice fishing rod racks 10 according to the present disclosure secured to a portable vessel 12. In the embodiment shown, the vessel 12 is a large bucket (e.g., 5 gallon bucket). The ice fishing rod racks 10 can alternatively be configured for securing to other portable devices or building structures (e.g., ice fishing house or garage wall). Each ice fishing rod rack 10 supporting an ice fishing rod 14 including a handle 16 and rod portion 18. The ice fishing rod rack 10 is configured to support the proximal end of the handle 16

In the embodiment shown, the ice fishing rod racks 10 are secured to an exterior of the vessel 12. Alternatively, the ice fishing rod racks 10 can be secured to an interior of the vessel 12. The ice fishing rod racks 10 may be secured to the vessel 12 using mechanical means. In an exemplary embodiment, described in more detail below, each ice fishing rod rack 10 includes a tab or protrusion configured to pass through corresponding holes or openings on the vessel 12. The ice fishing rod racks 10 may also be secured to the vessel 12 using chemical means, such as an adhesive on the side of the ice fishing rod racks 10 facing the vessel 12.

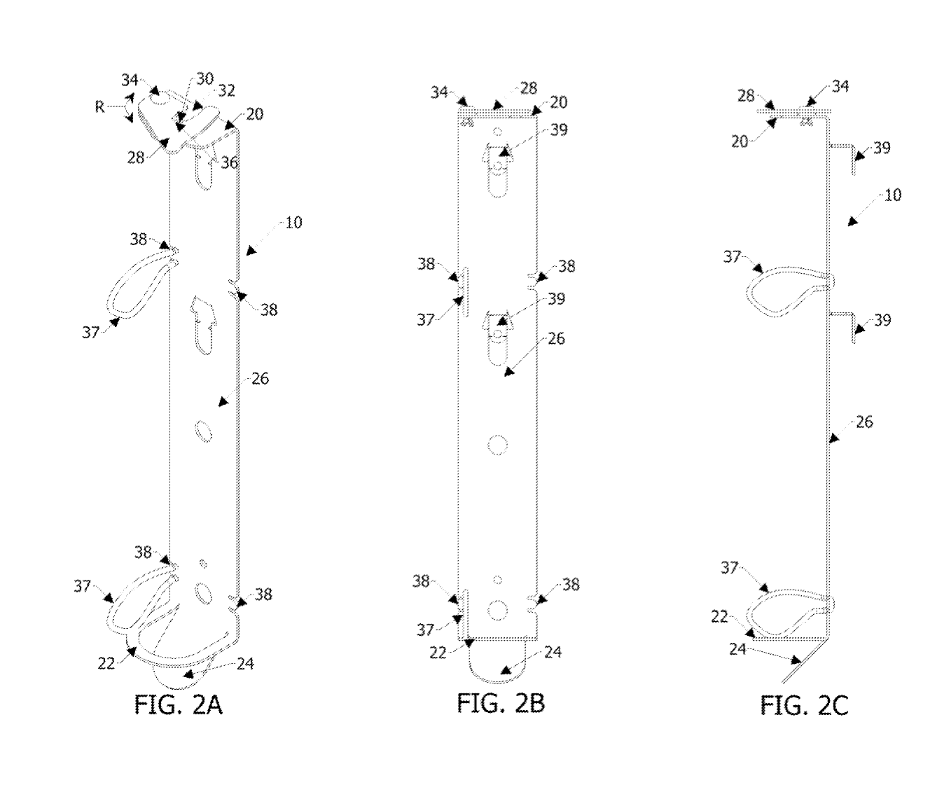

FIG. 2A is a perspective view of an ice fishing rod rack 10 according to the present disclosure. FIGS. 2B and 2C are front and side views of the ice fishing rod rack 10, respectively. The ice fishing rod rack 10 includes a rod support element 20, a handle support ring 22, a handle support tab 24, a base plate 26, and a securing element 28. The rod support element 20 and handle support ring 22 are substantially parallel to each other, and the handle support tab 24 is angled with respect to the handle support ring 22. In some embodiments, the rod support element 20 and handle support ring 22 are substantially orthogonal to the base plate 26. The base plate 26 extends between the rod support element 20 and the handle support ring 22 and tab 24. In some embodiments, the rod support element 20, handle support ring 22, handle support tab 24, and base plate 26 are formed of a unitary or continuous piece of material.

The rod support element 20 includes a notch 30 that is sized and shaped to receive the rod portion 18 of an ice fishing rod 14. The notch 30 includes a terminal end 32 against which the rod portion 18 rests when engaged with the notch 30. In alternative embodiments, the rod support element 20 is substantially semiannular in shape.

The handle support ring 22 is sized to receive a proximal portion of the handle 16 of an ice fishing rod 14, as shown in FIG. 1. In some embodiments, the handle support ring 22 is substantially orthogonal to the base plate 26 and has a substantially semiannular shape. In some embodiments, the handle support tab 24 is acutely angled with respect to the handle support ring 22. For example, in some implementations, the angle between the handle support tab 24 and the handle support ring 22 is between about 10° and about 75° (e.g., about 25°). When positioned in the ice fishing rod rack 10, the proximal end of the handle 16 is positioned against and supported by the handle support tab 24. When positioned in the ice fishing rod rack 10, the handle support ring 22 and handle support tab 24 support the handle 16 of the ice fishing rod 14 in three dimensions. The handle support tab 24 operates to stabilize the ice fishing rod 14 in a direction perpendicular to the plane of the rod support element 20 and handle support ring 22, while the handle support ring 22 stabilizes the ice fishing rod 14 in a plane parallel to the rod support element 20 and handle support ring 22.

The securing element 28 is rotatably coupled to the rod support element 20 via a coupling 34. The securing element 28 is rotatable in plane parallel to the rod support element 20. The securing element 28 includes a notch 36. To secure an ice fishing rod 14 in the ice fishing rod rack 10, the securing element 28 is rotated in a clockwise direction (when viewed from the top of the ice fishing rod rack 10) to allow the rod portion 18 to be inserted into the notch 32 of the rod support element 20. When the rod portion 18 is positioned in the notch 32, the securing element 28 is rotated such that the rod portion 18 passes through the notch 36 until the terminal end of the notch 36 is urged against the rod portion 18. Thus, when secured in place, the terminal ends of the notches 32 and 36 are adjacent to the rod portion 18, thereby surrounding the rod portion 18 and holding the rod portion 18 in place. In other words, the combination of the rod support element 20 and the securing element 28 operate to stabilize an ice fishing rod 14 relative to a plane parallel to the rod support element 20.

In some embodiments, the ice fishing rod rack 10 further includes one or more elastic bands 37 supportable by band catches 38 on opposing sides of the base plate 26. The elastic bands 37 can be permanently secured to the band catches 38 on one side of the base plate 26, or the elastic bands 37 can be removable from the ice fishing rod rack 10. In use, when an ice fishing rod 14 is placed in the ice fishing rod rack 10 as described above, the elastic bands 37 are securable around the ice fishing rod 14 by coupling the elastic bands 37 to the band catches 38 on opposing sides of the base plate 26. In some embodiments, the tension in the elastic bands 37 is such that the ice fishing rod 14 is urged against the base plate 26 by the elastic bands 37.

As shown in FIG. 2C, the base plate 26 includes two hooks or tabs 39 extending from the back side of the base plate 26. To secure the ice fishing rod rack 10 to the vessel 12, the hooks or tabs 39 can be passed through corresponding holes or slots in the vessel 12. For example, the hooks or tabs 39 can be formed perpendicular to the base plate 26, and then bent at a substantially right angle as is shown in FIG. 2C when the hooks or tabs 39 are inserted into the holes on the vessel 12. Alternatively, the ice fishing rod rack 10 can be secured to a vessel 12 or other structure using other mechanical means, such as screws, bolts with securing nuts, hook and loop couplings, and so on. Also, as discussed above, the ice fishing rod rack 10 can also be adhered to the vessel 12 or other structure.

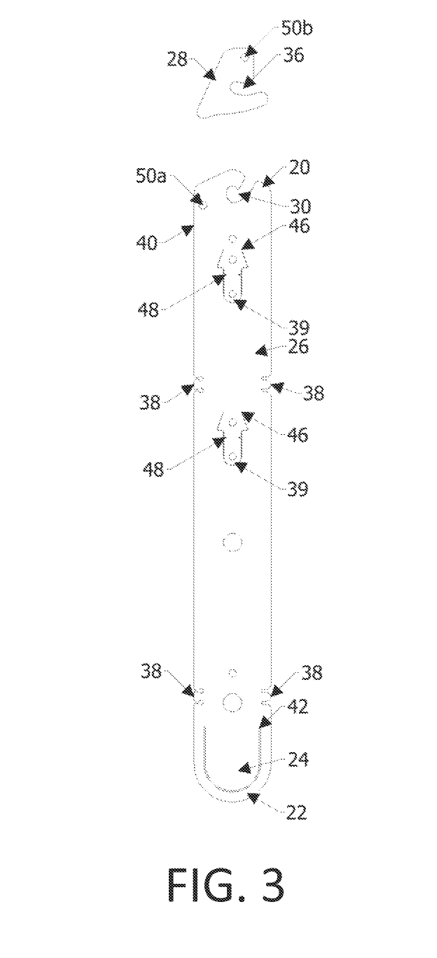

FIG. 3 is an exploded plan view of the ice fishing rod rack 10 according to an embodiment after being fabricated but prior to being assembled. For example, the components shown can be cut or punched from a sheet of material (e.g., metal) and then subsequently bent or otherwise formed into the assembly shown in FIGS. 2A-2C. In some embodiments, the base plate 26 and securing element 28 are formed as separate elements from the sheet of material. In the illustrated embodiment, holes, slots, and other features are formed on the base plate 26 to allow the rod support element 20 to be formed by bending the plate at bend point 40, to allow the handle support ring 22 and tab 24 to be formed by benign the plate at bend point 42, to facilitate formation of the hooks or tabs by bending at bend points 46 and 48, and to facilitate assembly of the securing element 28 to the rod support element 20 by riveting or otherwise coupling these two elements at connection holes 50a and 50b.

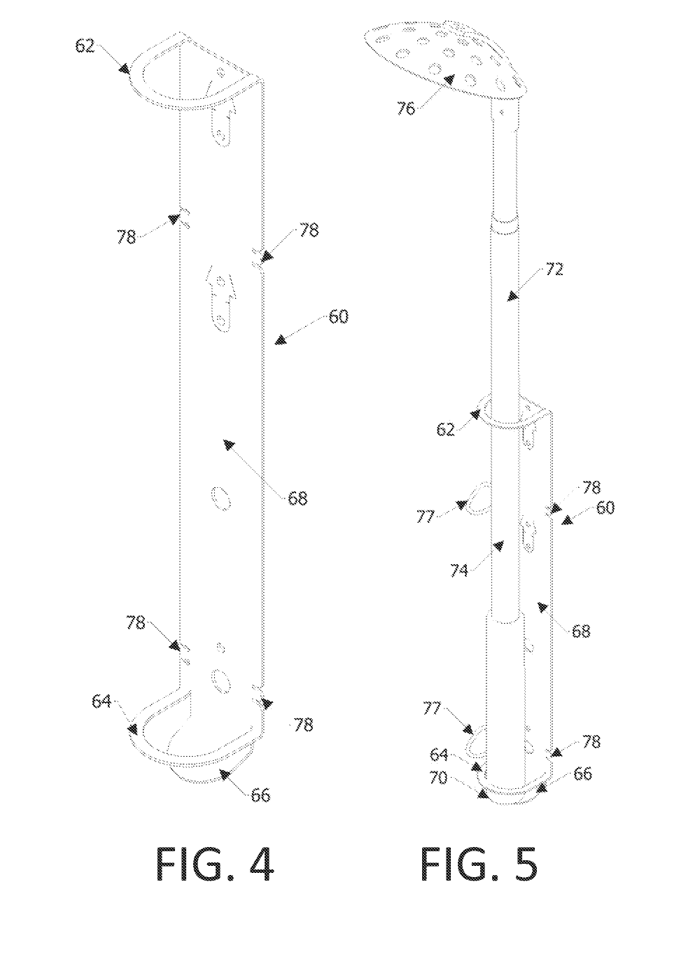

FIG. 4 is a perspective view of an ice fishing scoop rack 60 according to another embodiment of the present disclosure. The ice fishing scoop rack 60 includes an upper support element 62, a handle support ring 64, a handle support tab 66, and a base plate 68. The upper support element 62 and handle support ring 64 are substantially parallel to each other, and the handle support tab 66 is angled with respect to the handle support ring 64. In some embodiments, the upper support element 62 and handle support ring 64 are substantially orthogonal to the base plate 68. The base plate 68 extends between the upper support element 62 and the handle support ring 64 and tab 66. In some embodiments, the upper support element 62, handle support ring 64, handle support tab 66, and base plate 68 are formed of a unitary or continuous piece of material.

The upper support element 62 is configured to receive a handle end 70 of an ice fishing scoop 72, as shown in FIG. 5. The upper support element 62 is configured to surround the handle portion 74 extending between the handle end 70 and scoop 76. In some embodiments, the rod support element 20 is substantially semiannular in shape. The upper support element 62 operates to stabilize the ice fishing scoop 72 relative to a plane parallel to the upper support element 62.

The handle support ring 64 is sized to receive the handle end 70 the ice fishing scoop 70, as shown in FIG. 5. In some embodiments, the handle support ring 64 is substantially orthogonal to the base plate 68. In some embodiments, the handle support tab 66 is acutely angled with respect to the handle support ring 64. For example, in some implementations, the angle between the handle support tab 66 and the handle support ring 64 is between about 10° and about 75° (e.g., about 25°). When positioned in the ice fishing scoop rack 60, the handle end 70 is positioned against and supported by the handle support tab 66. The handle support ring 64 and handle support tab 66 support the handle end 70 of the ice fishing rod 14 in three dimensions. That is, the handle support tab 66 operates to stabilize the ice fishing scoop 72 in a direction perpendicular to the plane of the upper support element 62 and handle support ring 64, while the handle support ring 64 stabilizes the ice fishing scoop 72 in a plane parallel to the upper support element 62 and handle support ring 64.

In some embodiments, the ice fishing scoop rack 60 further includes one or more elastic bands 77 supportable by band catches 78 on opposing sides of the base plate 68. The elastic bands 77 can be permanently secured to the band catches 78 on one side of the base plate 68, or the elastic bands 67 can be removable from the ice fishing scoop rack 60. In use, when an ice fishing scoop 72 is placed in the ice fishing scoop rack 60 as described above, the elastic bands 77 are securable around the ice fishing scoop 72 by coupling the elastic bands 77 to the band catches 78 on opposing sides of the base plate 68. In some embodiments, the tension in the elastic bands 77 is such that the ice fishing scoop 72 is urged against the base plate 68 by the elastic bands 77.

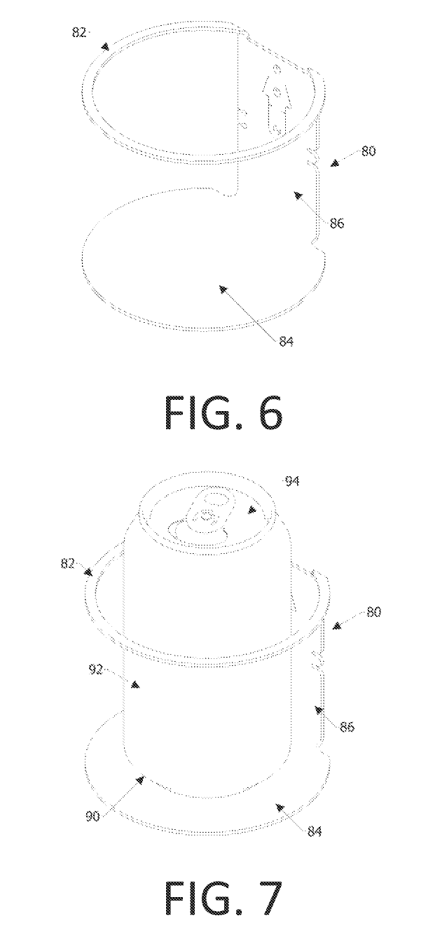

As is known, an important accessory to ice fishing is a selection of preferred beverages, not only to pass the time while waiting for the next catch, but also, at times, to ward off the effects of the cold. FIG. 6 is a perspective view of a beverage container rack 80 according to another embodiment of the present disclosure. The beverage container rack 80 includes an upper support element 82, a lower support element 84, and a base plate 86. The upper support element 82 and lower support element 84 are substantially parallel to each other. In some embodiments, the upper support element 82 and handle support ring 84 are substantially orthogonal to the base plate 86. The base plate 86 extends between the upper support element 82 and lower support element 84. In some embodiments, the upper support element 82, lower support element 84, and base plate 86 are formed of unitary or continuous piece of material.

The upper support element 82 is sized and shaped to receive a bottom 90 of beverage container 92, as shown in FIG. 7. The upper support element 82 is configured to surround the beverage container 92 between the bottom 90 and top 94 of the beverage container 92. In some embodiments, the upper support element 82 is substantially semiannular in shape. The upper support element 82 operates to stabilize the beverage container 92 relative to a plane parallel to the upper support element 82. It will be appreciated that while beverage container 92 is illustrated as a can in FIG. 7, any other type of beverage container can be supported by the beverage container rack 80, such as a bottle.

The lower support element 84 is substantially planar and continuous to support the bottom 90 of the beverage container 92, as shown in FIG. 5. In some embodiments, the lower support element 84 is substantially orthogonal to the base plate 86. When positioned in the beverage container rack 80, the bottom 90 of the beverage container is positioned against and rests on the lower support element 84. When positioned in the beverage container rack 80, the upper support element 82 and lower support element 84 support the beverage container 92 in three dimensions. That is, the upper support element 82 operates to stabilize the beverage container 92 in a direction parallel to the plane of the upper support element 82 and lower support element 84, while the lower support element 84 stabilizes the beverage container 92 in a direction perpendicular to the plane of the upper support element 82 and lower support element 84.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features. For example, the racks shown are merely for illustration, and the racks of the present disclosure can be configured to accommodate other types of ice fishing accessories.

I claim:

1. An ice fishing rod rack comprising:
a rod support element including a first notch configured to receive a rod portion of an ice fishing rod;
a handle support ring and tab, the handle support ring extending substantially parallel to the rod support and the handle support tab acutely angled with respect to the handle support ring, the handle support ring configured to receive a proximal portion of an ice fishing rod handle, and the handle support tab positioned to support the proximal end of the ice fishing rod handle;
a base plate extending between the rod support and the handle support ring and tab; and
a securing element rotatably secured to the rod support element and including a second notch, wherein the securing element is rotatable to urge terminal ends of the first and second notches against the rod portion to hold the rod portion against the rod support element.

2. The ice fishing rod rack of claim 1, wherein the rod support element has a semiannular shape.

3. The ice fishing rod rack of claim 1, wherein the rod support element, handle support ring and tab, and base plate are comprised of a continuous piece of material.

4. The ice fishing rod rack of claim 1, wherein the rod support element, handle support ring and tab, base plate, and/or securing element are comprised of metal.

5. The ice fishing rod rack of claim 1, wherein the rod support element, handle support ring and tab, base plate, and/or securing element are comprised of plastic.

6. The rack of claim 12, and further comprising first and second elastic band catches on the base plate, the first and second elastic band catches disposed on opposite sides of the base plate and configured to secure an elastic band across the ice fishing rod.

7. The ice fishing rod rack of claim 1, wherein the base plate comprises a coupling means configured to secure the ice fishing rod rack to a support substrate.

8. The ice fishing rod rack of claim 7, wherein the coupling mechanism comprises one or more hooks formed in the base plate.

9. The ice fishing rod rack of claim 7, wherein the support substrate is a portable vessel.

10. The ice fishing rod rack of claim 1, wherein the angle between the handle support tab and the handle support ring is between about 10° and about 75°.

11. A method for using the ice fishing rod rack of claim 1, the method comprising:
placing the proximal end of the ice fishing rod handle through the handle support ring and against the handle support tab;
placing the rod portion of the ice fishing rod against the terminal end of the first notch on the rod support element; and
rotating the securing element until the terminal end of the second notch is against rod portion.

12. A rack for supporting an ice fishing accessory comprising:
a base plate having a first end and second end;
a first support element extending substantially orthogonally from the base plate at the first end, the first support element including a structure configured to stabilize the ice fishing accessory with respect to a major plane of the first support element; and
a second support element extending from the second end of the base plate and configured to contact a bottom portion of the ice fishing accessory to stabilize the ice fishing accessory at least with respect to a direction perpendicular to the major plane of the first support element.

13. The rack of claim 12, wherein the first support element has a semiannular shape.

14. The rack of claim 12, wherein the second support element includes a handle support ring and handle support tab, the handle support ring extending substantially parallel to the first support element and the handle support tab angled with respect to the handle support ring.

15. The rack of claim 14, wherein the angle between the handle support tab and the handle support ring is between about 10° and about 75°.

16. The rack of claim 12, wherein the first support element comprises a stationary support element including a first notch and a securing element including a second notch, the securing element rotatably secured to the stationary support element, the securing element rotatable to urge terminal ends of the first and second notches against the ice fishing accessory.

17. The rack of claim 12, wherein the base plate comprises a coupling mechanism configured to secure the ice fishing rod rack to a support substrate.

18. The rack of claim 17, wherein the coupling mechanism comprises one or more hooks formed in the base plate.

19. The rack of claim 12, and further comprising first and second elastic band catches on the base plate, the first and second elastic band catches disposed on opposite sides of the base plate and configured to secure an elastic band across the ice fishing accessory.

20. The rack of claim 12, wherein the base plate, first support element, and second support element are comprised of a continuous piece of material.
